(19) United States
(12) Patent Application Publication
(10) Pub. No.: US 2022/0099292 A1
(43) Pub. Date: Mar. 31, 2022

(54) PORTABLE HOT AIR GENERATOR APPARATUS COMPRISING A DAMPING SYSTEM

(71) Applicant: SEFMAT, Le Haillan (FR)

(72) Inventor: François CLEMENT, Le Haillan (FR)

(21) Appl. No.: 17/490,207

(22) Filed: Sep. 30, 2021

(30) Foreign Application Priority Data
Sep. 30, 2020 (FR) 2009978

(51) Int. Cl. F23D 14/52; F23D 14/38; F23D 14/56

(52) U.S. Cl. CPC F23D 14/52; F23D 14/38; F23D 2900/00013; F23D 2207/00; F23D 14/56

(57) ABSTRACT

Disclosed is a portable hot air generator apparatus which includes a handle and a body forming a Venturi and, furthermore, a damping system between the handle and the body.

This application claims priority to FR Patent Application No. 2009978 filed Sep. 30, 2020, the entire contents of which are hereby incorporated by reference.

### BACKGROUND OF THE INVENTION

### Field of the Invention

The present invention relates to a burner/hot air generator apparatus, hereinafter referred to as an apparatus, which can be used, in particular but not exclusively, for the low temperature heating of plastic film, for example of polyethylene film for their shrinkage by means of a gas flow originating from the combustion of a combustible gas such as propane and air or for laying a thermoplastic material on the ground. These apparatuses are commonly known as a shrink gun.

### Description of the Related Art

A shrink gun is essentially composed of a supply controlled by a trigger to supply a Venturi, from an external source of gas, for example LPG, at a pressure above atmospheric pressure. A flammable “gas-atmospheric air” mixture is formed in the Venturi and emerges in a combustion chamber, where it is burnt. The gas mixture thus formed is ignited at the terminals of a spark plug by a spark whose electrical energy is produced by a piezoelectric igniter located inside the gun and actuated when the trigger is depressed.

The Venturi and the combustion chamber together form a substantially tube-shaped body. The upstream side of the tube forms an air intake for the Venturi. The downstream forms a diffuser for the hot gases produced by the apparatus.

The different functions fulfilled by this tube impose changes in section and shape which make it complex to produce. Thus, the tube is generally formed in two parts; a first part forms the Venturi, the second part forms the diffuser and is used as a combustion chamber. The diffuser is attached and assembled on the Venturi, by fitting or screwing.

This arrangement requires many manipulations during the manufacture of the apparatus and makes it fragile during use.

### SUMMARY OF THE INVENTION

Thus, a first purpose of the invention is to provide a body that is more robust and simpler to manufacture.

Furthermore, a shrink gun, like all hand-held apparatuses, are under heavy stress and regularly experience drops to the ground.

Thus, a second purpose of the invention is to provide an apparatus whose impact resistance, particularly in the event of a fall, is improved.

According to a first object of the invention, a portable hot air generator apparatus comprises a body mainly formed of two blanks substantially symmetrical to each other relative to a plane of symmetry, each blank being formed from a single piece of stamped sheet metal and comprising a first part, of semi-circular section, which forms a wall of a Venturi and a second part extending this first part forward and which forms a diffuser.

Advantageously, each blank comprises at the top and at the bottom, where the blanks meet on the plane of symmetry, flat edges parallel to the plane. Preferably, the blanks are assembled with a dry seal.

According to a second object of the invention, a portable hot air generator apparatus comprises a handle and a body which extends along a horizontal main axis and substantially symmetrical relative to a vertical longitudinal plane and, furthermore, a system for damping between the handle and the body, so that the handle does not have direct contact with the body.

The system may comprise at least one damper, preferably two dampers, each damper comprising a housing, a cleat and a damping material, the housing being formed in the handle, the cleat being integral with the body, and, the material forming an elastic grip for one end of the cleat in the housing, at a distance from the walls of this housing. The cleat advantageously comprises a shank which extends vertically downwards from the body and a crossbar at a distal end from the shank, the housing comprising an opening for the passage of the shank with clearance. Preferably, the handle comprises two shells substantially symmetrical to each other relative to the plane of symmetry, each of the shells forming a part of the housing which is open laterally.

The handle may comprise two shells substantially symmetrical to each other relative to the plane of symmetry, each of these shells comprising ribs, perpendicular to the plane of symmetry, the damping system comprising a layer of damping material disposed on a ridge of the ribs, between the body and the shell.

### BRIEF DESCRIPTION OF THE DRAWINGS

Embodiments and variants will be described below, by way of non-limiting examples, with reference to the appended drawings wherein:

FIG. 1 is a view of a hot air generator apparatus, in a first embodiment of the invention, in schematic section in longitudinal elevation, according to a section plane I-I of FIG. 2;

FIG. 2 is a schematic cross-sectional view of the apparatus of FIG. 1, along a section plane II-II of FIG. 1;

FIG. 3 is a schematic longitudinal elevational view of a hot air generator apparatus, in a second embodiment of the invention where, in particular, the body is made in two blanks substantially symmetrical to each other;

FIG. 4 is a perspective view of a blank for forming a body of the apparatus of FIG. 3;

FIG. 5 is a perspective view of the handle of the apparatus of FIG. 3; and,

FIG. 6 is a schematic cross-sectional view of the apparatus of FIGS. 3-4.

### DESCRIPTION OF THE PREFERRED EMBODIMENTS

The figures illustrate a hot air generator apparatus 1, in two different embodiments. Such an apparatus is portable, that is to say that it can be held in the hand, like a gun of which it has substantially the shape. It can be used, but not exclusively, for the low temperature heating of plastic films, for example polyethylene film, for their shrinkage by means of a flow of hot air coming from the combustion of a fuel gas such as propane and air, or for laying a thermoplastic material on the ground. It can also be used for thermal weed control; in particular in the latter case, it can be fitted with an extender.

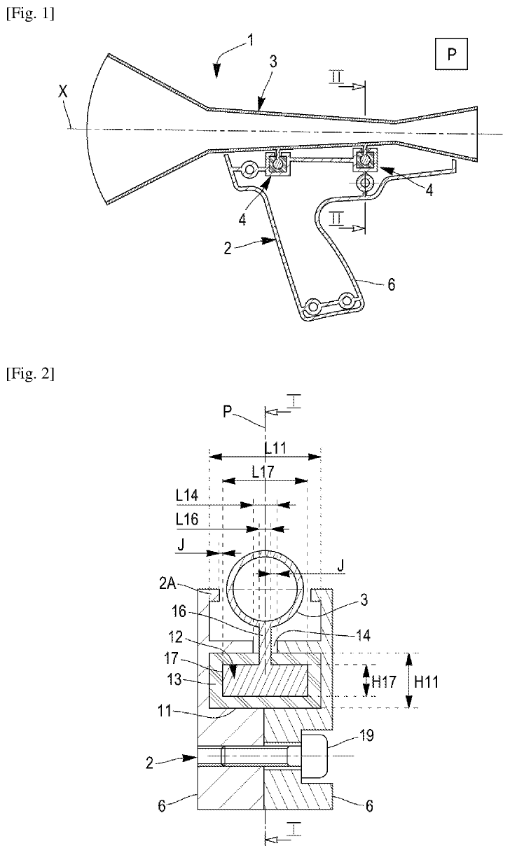

A first embodiment of such an apparatus 1 is illustrated in FIGS. 1 and 2. Such an apparatus is generally substantially symmetrical relative to a plane P and includes a main axis X. In the description, in particular the terms top, bottom, front, rear allow the apparatus to be described by considering it in a position such that the plane P is vertical and the main axis X is horizontal, the hot air produced by the apparatus being expelled towards the front of the apparatus.

In FIG. 1, the apparatus 1 is shown in elevation and in longitudinal section along the plane of symmetry P.

The apparatus 1 mainly comprises a handle 2 and a body 3. The body and the handle are substantially rigid. The body is substantially in the shape of a tube of revolution around the main axis X, extended by a flattened part serving as a diffuser. The apparatus further comprises a damping system comprising two dampers 4.

Each damper comprises a housing 11, a cleat 12 and a damping material 13.

The housing 11 is formed in the handle 2. The housing 11 comprises an opening 14, upwards. The cleat 12 is integral with the body 3 and extends downwards from this body, through the opening 14, into the housing 11, without contact with the shells 6. The damping material 13 isolates the cleat from the walls of the housing 11, and maintains the cleat in the housing.

In the example illustrated, the cleat has an inverted “T” shape, the shank 16 of which extends from the body 3 through the opening 14, and a crossbar 17 is embedded in the damping material 13. As illustrated in FIG. 2, in cross section, the housing 11 has a width L11 and a height H11 respectively greater than the width L17 and the height H17 of the bar 17, so that the bar 17 is sufficiently surrounded by material 13, without contact with the handle 2. Furthermore, the opening 14 has a width L14 greater than the width L16 of the shank 16, so as to ensure a sufficient clearance J, between the walls of the opening 14 and the shank 16. As illustrated in FIG. 1, the same applies to the longitudinal dimensions. Also, a sufficient clearance J is maintained between the body 3 and other parts 2A of the handle 2. In addition, the width L17 of the bar 17 is greater than the width L14 of the opening 14, so that the damper ensures a positive fastening of the body on the handle, that is to say without the risk of the body detaching from the handle, even in the event of degradation of the material 13. Preferably, the material 13 is an elastomer.

In the example illustrated, the handle 2 is formed of two shells 6 substantially symmetrical to each other relative to the plane of symmetry P. They are fastened to one another by a system of screws 19. The housing 11 is formed by the assembly of the two shells, so that before this assembly the housing is in two parts open laterally. Thus, the bar 17 of the cleat 12 can be inserted into one of the parts, before assembling the shells 6. After assembling the shells, the bar 17 is trapped in the housing, thus ensuring the positive fastening of the body on the handle.

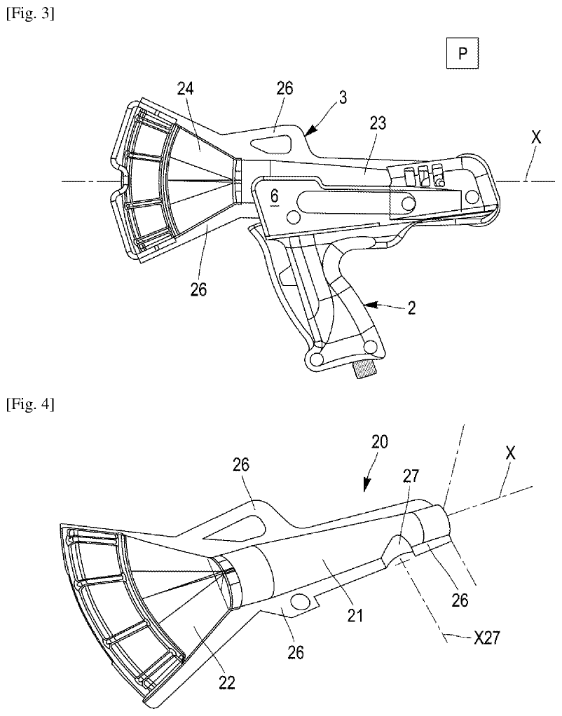

FIGS. 3 to 6 illustrate a second embodiment for a hot air generator apparatus 1 according to the invention. This second embodiment will be described in that it differs from the first embodiment, previously described.

In this example, as particularly illustrated in FIGS. 3, 4 and 5, the body 3 is mainly formed of two blanks 20 which are symmetrical to each other relative to the plane of symmetry P. Each blank is formed from a single piece of stamped sheet. It comprises a first part 21 of semi-circular section, of revolution about the longitudinal axis X; it forms a wall of the Venturi 23. A second part 22 extends the first part forward, crashing and flaring, from back to front; it forms a wall of the diffuser 24.

Each blank 20 comprises, at the top and at the bottom, where the blanks meet on the plane of symmetry P, flat edges 26 parallel to the plane P. When the blanks are kept pressed against each other, the edges 26, sufficiently wide, form therebetween a dry seal guaranteeing sufficient sealing around the gas flow which passes longitudinally through the body 3.

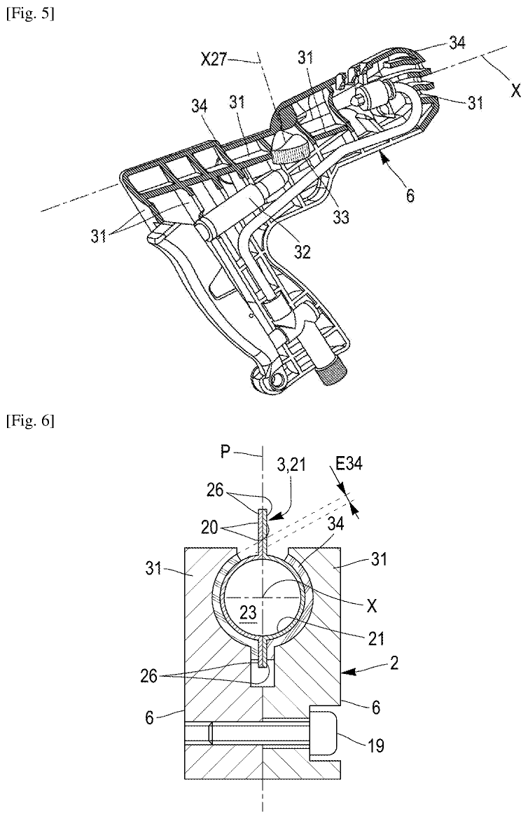

At the bottom, between the flat edges, each blank forms a vault 27, of revolution about a secondary axis X27, substantially vertical and perpendicular to the main axis X. A stopper 33, illustrated in FIG. 5, is provided to be disposed between the vaults to sealingly pass therein a wire electrically supplying a spark plug from a piezoelectric igniter 32; the spark plug and the wire are not shown in the figures.

As particularly illustrated in FIGS. 5 and 6, as well as in the first embodiment, the handle 2 comprises two shells 6 assembled together by a system of screws 19. In the second embodiment, each shell 6 comprises a framing of ribs 31, substantially perpendicular to the plane of symmetry P. The primary functions of these ribs are to form the transverse walls of each shell 6 and to ensure sufficient rigidity.

As in the first embodiment, the apparatus 1 comprises a damping system between the body 3 and the handle 2. This system comprises a layer 34 of damping material glued to the ridge of the ribs 31, in the upper part of each shell. The layer 34 has a thickness E34, measured in a transverse plane, substantially constant. Preferably, the layer 34 is made of elastomer.

As illustrated in FIG. 6, the layer 34 provides an elastic interface between the handle 2 and the body 3, both on the tubular part 23, 24 and on the flat edges, without the body being in contact with any of the shells 6. A pressure exerted by the layer 34 on the flat edges 26 allows to ensure a sufficient sealing between the flat edges 26, even with a dry seal.

Moreover, the shells partially fold over the first part 21 of the body 3, so that after assembling the shells together, they ensure a positive fastening of the body on the handle.

Of course, the invention is not limited to the examples which have just been described. On the contrary, the invention is defined by the following claims.

It will indeed appear to the person skilled in the art that various modifications can be made to the embodiments described above, in light of the teaching which has just been disclosed to them.

Thus, instead of a dry joint, the blanks can be assembled by welding or gluing.

Also, the body can be made integrally, for example by moulding.

The number of dampers may vary depending on the shape of the diffuser.

Also, each “cleats” can be a fold in the sheet of the body; this fold may form a tab, which engages in the damping material. A damper can also, for example, be in the shape of a ring that surrounds the body, so that there is no need for a cleat to hold it therein.

A generator according to the invention has many advantages over a generator of the prior art; in particular:
it has a significantly reduced manufacturing cost; and,
it has improved resistance. By separating the handle from the body, it prevents the handle from breaking, in particular during a fall on the body, the impact of which would be transmitted directly to a plastic handle.

1. A portable hot air generator apparatus comprising:
a handle and a body which extends along a horizontal main axis and substantially symmetrical relative to a vertical longitudinal plane; and
a system for damping between said handle and said body, so that the handle does not have direct contact with the body.

2. The apparatus according to claim 1, wherein the damping system comprises at least one damper, each damper comprising a housing, a cleat and a damping material, said housing being formed in the handle, said cleat being integral with the body, and, said material forming an elastic grip for one end of the cleat in the housing, at a distance from the walls of said housing.

3. The apparatus according to claim 2, wherein the cleat comprises a shank which extends vertically downwards from the body and a crossbar at a distal end from said shank, and wherein the housing comprises an opening for the passage of the shank with clearance.

4. The apparatus according to claim 2, wherein the cleat is a fold in the sheet of the body which forms a tab engaging in the damping material.

5. The apparatus according to claim 2, wherein the handle comprises two shells substantially symmetrical to each other relative to the plane of symmetry, each of said shells forming a part of the housing which is open laterally.

6. The apparatus according to claim 2, further comprising two dampers.

7. The apparatus according to claim 1, wherein the damping system comprises at least one damper in the shape of a ring that surrounds the body.

8. The apparatus according to claim 1, wherein the handle comprises two shells substantially symmetrical to each other relative to the plane of symmetry, each of said shells comprising ribs, perpendicular to said plane of symmetry, the damping system comprising a layer of damping material disposed on a ridge of said ribs, between the body and said shell.

9. The apparatus according to claim 1, wherein the body is mainly formed of two blanks substantially symmetrical to each other relative to the plane of symmetry, each blank being formed from a single piece of stamped sheet metal and comprising a first part of semi-circular section, of revolution about the longitudinal axis X, which forms a wall of a Venturi and a second part extending said first part forward which forms a diffuser.

10. The apparatus according to claim 9, wherein each blank comprises at the top and at the bottom, where the blanks meet on the plane of symmetry, flat edges parallel to the plane.

11. The apparatus according to claim 10, wherein the blanks are assembled with a dry seal.

12. The apparatus according to claim 3, wherein the handle comprises two shells substantially symmetrical to each other relative to the plane of symmetry, each of said shells forming a part of the housing which is open laterally.

13. The apparatus according to claim 4, wherein the handle comprises two shells substantially symmetrical to each other relative to the plane of symmetry, each of said shells forming a part of the housing which is open laterally.

14. The apparatus according to claim 3, further comprising two dampers.

15. The apparatus according to claim 4, further comprising two dampers.

16. The apparatus according to claim 5, further comprising two dampers.

17. The apparatus according to claim 12, further comprising two dampers.

18. The apparatus according to claim 13, further comprising two dampers.
